(19) United States
(12) Patent Application Publication
(10) Pub. No.: US 2026/0161052 A1
(43) Pub. Date: Jun. 11, 2026

(54) IMAGING APPARATUS

(71) Applicant: i-PRO Co., Ltd., Tokyo (JP)

(72) Inventors: Koji ABE, Tokyo (JP); Kento TANAKA, Tokyo (JP)

(73) Assignee: i-PRO Co., Ltd., Tokyo (JP)

(21) Appl. No.: 19/180,343

(22) Filed: Apr. 16, 2025

(30) Foreign Application Priority Data
May 8, 2024 (JP) 2024-076051

(51) Int. Cl. G03B 17/08; G03B 17/55

(52) U.S. Cl. CPC G03B 17/08; G03B 17/55

(57) ABSTRACT

An imaging apparatus includes a camera housing having an opening through which an imaging unit accommodated inside the camera housing is exposed toward a subject side, and a cover unit in which a cover glass capable of transmitting light, a heater for removing fogging on the cover glass, a base member disposed on an opposite side to the cover glass with the heater interposed therebetween, and an exterior cover for covering the subject side of the cover glass are stacked, in which the cover unit is attached to the camera housing by covering the opening with the cover glass and bringing the exterior cover into contact with a surface of the camera housing on the subject side.

### CROSS-REFERENCE TO RELATED APPLICATIONS

This application claims the benefit of priority to Japanese Patent Application Number 2024-076051 filed on May 8, 2024. The entire contents of the above-identified application are hereby incorporated by reference.

### TECHNICAL FIELD

The present invention relates to an imaging apparatus.

### BACKGROUND

In the related art, regarding an imaging apparatus installed outdoors, a technique is known in which a heater is attached to a cover glass covering an imaging unit to remove fogging on the cover glass (for example, refer to JP 2005-94545 A and JP 2003-31398 A).

### SUMMARY

However, in imaging apparatuses disclosed in JP 2005-94545 A and JP 2003-31398 A, the cover glass to which the heater is attached is disposed inside a housing. Therefore, when it is desired to replace the cover glass due to damage to the cover glass or a malfunction of the heater, it is necessary to disassemble the housing to access the cover glass or the like inside the housing, which is very time-consuming.

An object of the present invention is to provide an imaging apparatus that enables a cover glass with a heater to be easily replaced.

In order to achieve the above object, there is provided an imaging apparatus including an imaging unit configured to capture a subject, a camera housing having an opening through which the imaging unit accommodated inside the camera housing is exposed toward a subject side, and a cover unit in which a cover glass configured to transmit light, a heater configured to remove fogging on the cover glass, a base member disposed on an opposite side to the cover glass with the heater interposed therebetween, and an exterior cover configured to cover the subject side of the cover glass are laminated, in which the cover unit is attached to the camera housing by covering the opening with the cover glass and bringing the exterior cover into contact with a surface of the camera housing on the subject side.

According to the present invention, it becomes possible to easily perform a replacement operation of a cover glass with a heater.

### BRIEF DESCRIPTION OF DRAWINGS

FIG. 1 is an external perspective view of a surveillance camera according to an embodiment.

FIG. 2 is a front view of the surveillance camera.

FIG. 3 is a perspective view of a camera unit.

FIG. 4 is a side view of the surveillance camera.

FIG. 5 is an exploded perspective view of the camera unit.

FIG. 6 is a perspective view of a camera housing, an imaging unit, and a first water-blocking member.

FIG. 7 is a cross-sectional view of a main part of the camera unit taken along line VII-VII in FIG. 3.

FIG. 8 is an exploded perspective view of a cover unit.

FIG. 9 is a rear-side perspective view of a cover glass.

FIG. 10 is a rear-side perspective view of an exterior cover.

FIG. 11 is a cross-sectional view of a main part of the imaging unit taken along line XI-XI in FIG. 3.

FIG. 12 is a perspective view of a substrate, a second water-blocking member, and a base member supporting the substrate and the second water-blocking member.

FIG. 13 is a rear-side perspective view of the substrate, the second water-blocking member, and the base member supporting the substrate and the second water-blocking member.

FIG. 14 is a cross-sectional view of a main part of the camera unit taken along line XIV-XIV in FIG. 3.

### DESCRIPTION OF EMBODIMENTS

Hereinafter, an embodiment of the invention will be described with reference to the drawings. The embodiment contributes to “9. Basis of Industry and Technical Innovation” of Sustainable Development Goals (SDGs) proposed by UN by realizing a highly versatile imaging apparatus.

### Overall Configuration of Surveillance Camera

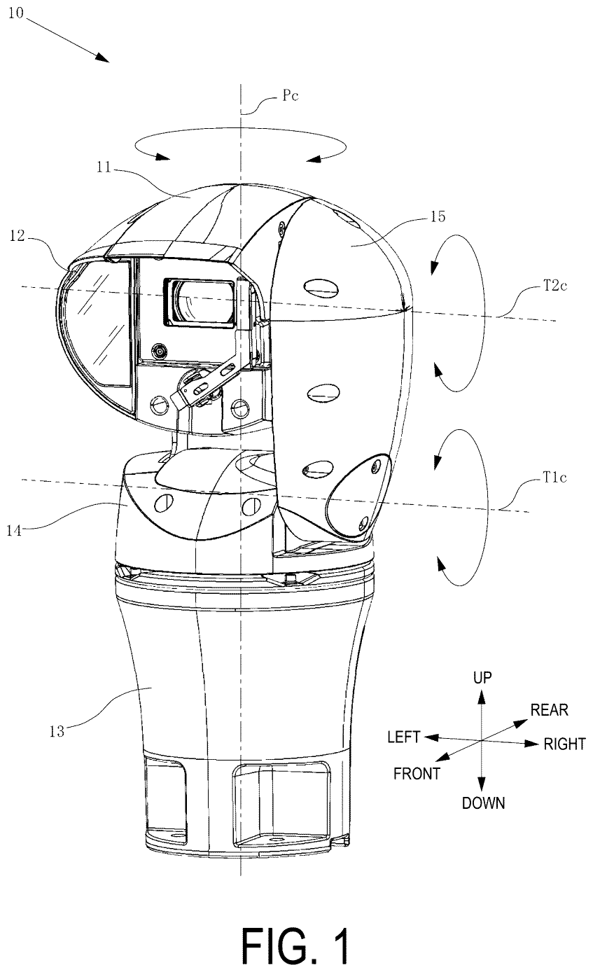

Hereinafter, a surveillance camera, which is an aspect of an imaging apparatus according to an embodiment of the present invention, will be described. As shown in FIG. 1, a surveillance camera 10 includes a camera unit 11, an illumination unit 12, an apparatus base 13, a rotary table 14, and a support arm 15.

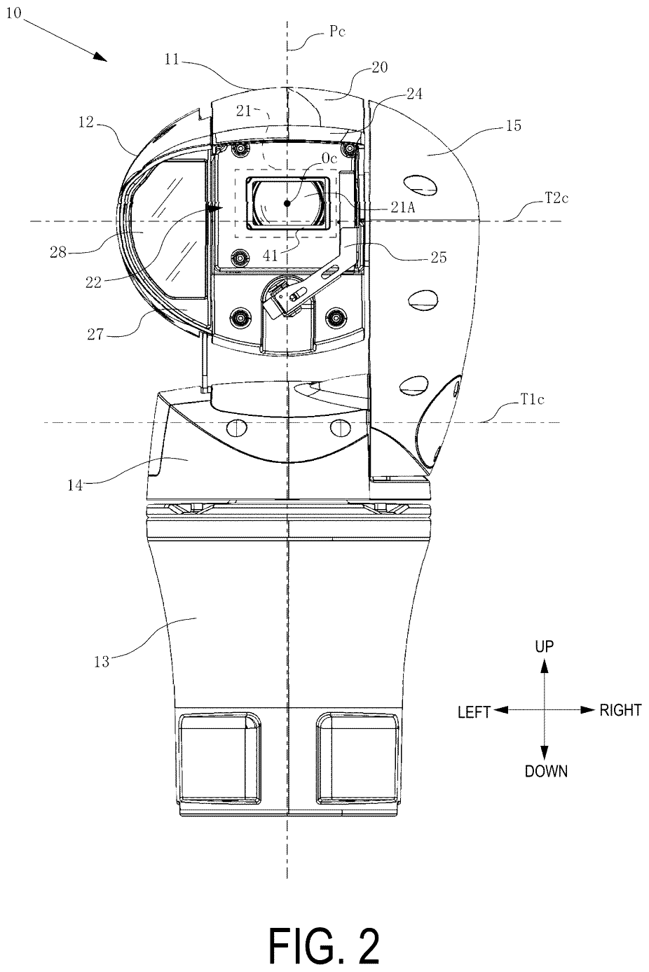

In the present specification, assuming a posture of the surveillance camera 10 when an optical axis Oc of the imaging unit 21 is orthogonal to a pan axis Pc and a first tilt axis T1c (a posture in FIG. 2), an extension direction of the pan axis Pc (an up-down direction on the paper surface in FIG. 2) is defined as an up-down direction, an extension direction of the first tilt axis T1c (a left-right direction on the paper surface in FIG. 2) is defined as a left-right direction, and a direction orthogonal to the pan axis Pc and the first tilt axis T1c (a direction orthogonal to the paper surface in FIG. 2) is defined as a front-rear direction. In addition, in the posture of the surveillance camera 10 in FIG. 2, a direction in which the imaging unit 21 captures an image is referred to as “front”, and an opposite direction is referred to as “rear”. Furthermore, when the surveillance camera 10 of FIG. 2 is viewed from the front (front side), the upper side, the lower side, the left side, and the right side (that is, corresponding to the upper, lower, left, and right sides on the paper surface of FIG. 2) are defined. However, each of the above-described directions is relative, and changes in accordance with a change in the installation direction of the surveillance camera 10 and a change in the posture of the surveillance camera 10.

The apparatus base 13 is formed in a substantially cylindrical shape in which an area of an upper surface (a surface on a side facing the rotary table 14) is larger than an area of a lower surface (a lower surface in FIG. 1). The lower surface of the apparatus base 13 is a mounting surface, and the apparatus base 13 is fixed to a fixed surface such as a floor, a ceiling, a wall, or a pole by a fastener such as a bolt.

As shown in FIG. 2, the rotary table 14 is disposed on the upper surface of the apparatus base 13 and is supported with respect to the apparatus base 13 so as to be rotatable about the pan axis Pc extending in the up-down direction. The pan axis Pc coincides with a central axis of the apparatus base 13.

One end (lower end) of the support arm 15 is attached to the rotary table 14. The other end (upper end) of the support arm 15 is attached to a side surface of the camera unit 11 described below. The support arm 15 is adapted to be rotatable about the pan axis Pc integrally with the rotary table 14. One end of the support arm 15 is supported with respect to the rotary table 14 so as to be rotatable about the first tilt axis T1c extending in the left-right direction. The first tilt axis T1c is orthogonal to the pan axis Pc and the optical axis Oc. That is, the support arm 15 is adapted to be rotatable with respect to the rotary table 14 about the first tilt axis T1c.

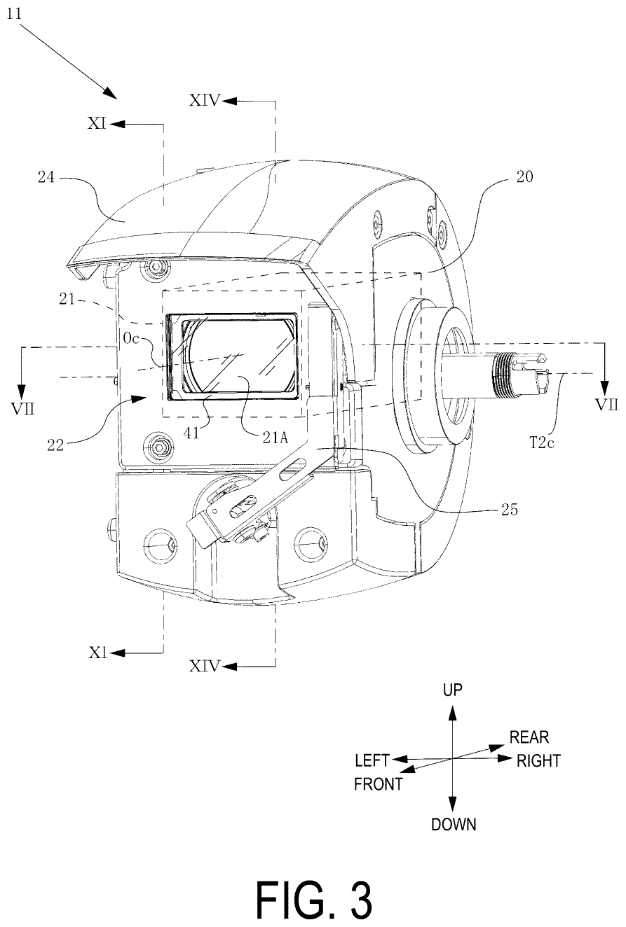

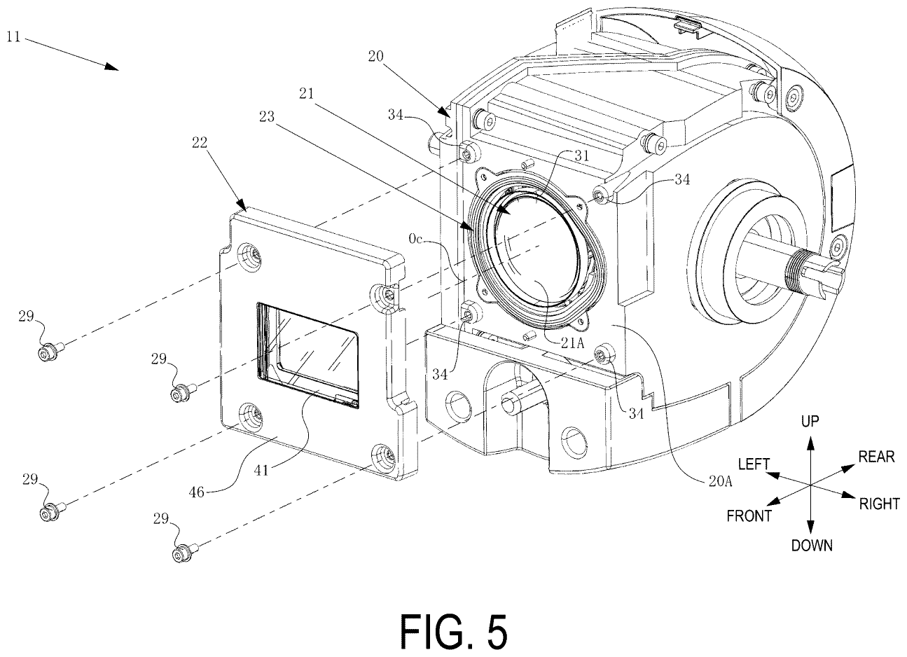

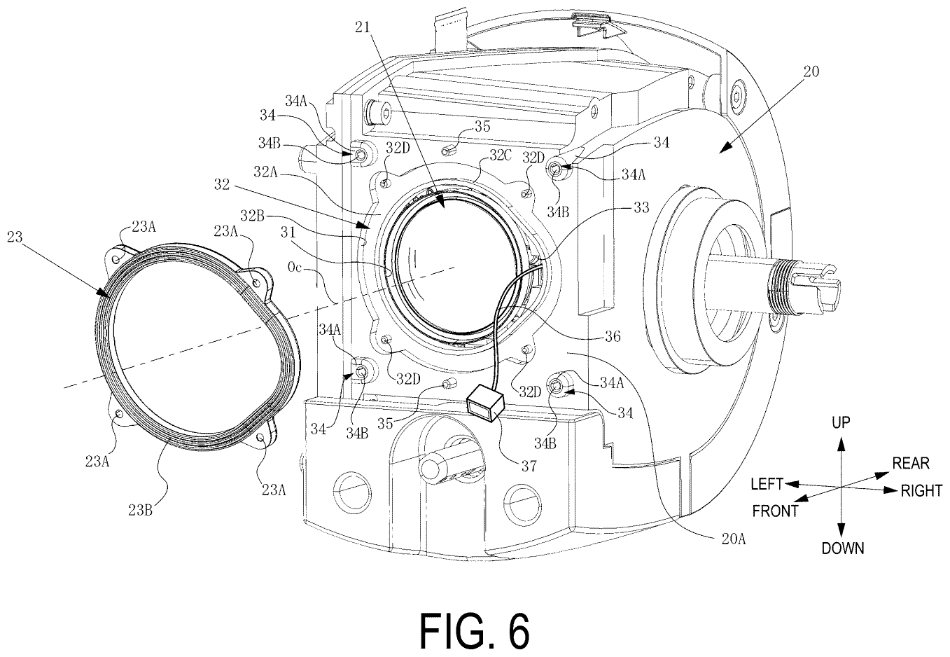

As shown in FIG. 3, the camera unit 11 includes a camera housing 20, an imaging unit 21, a cover unit 22, and a first water-blocking member 23 (see FIGS. 5 and 6). The camera housing 20 is formed in a substantially quadrangular shape in a front view and a substantially elliptical shape in a side view. The imaging unit 21 includes a lens 21A and an imaging device (not shown). In the imaging unit 21, a subject image is formed on the imaging device by the lens 21A, and the imaging device captures the subject image. The cover unit 22 is provided in front of the camera housing 20.

The lens 21A of the imaging unit 21 is covered by a cover glass 41 of the cover unit 22, which will be described below. In addition, the camera unit 11 includes a shielding portion 24 and a wiper 25. The shielding portion 24 is located at a position above the cover glass 41 of the camera housing 20, protrudes forward of the cover glass 41 of the camera housing 20, and protects the imaging unit 21 and the cover glass 41 from sunlight or the like. The wiper 25 moves between a position where it covers a front surface of the cover glass 41 and a position where it is retracted from the cover glass 41 to remove dirt on the cover glass 41.

One side surface (right side surface) of the camera unit 11 is supported with respect to the other end of the support arm 15 so as to be rotatable about a second tilt axis T2c extending in the left-right direction. The second tilt axis T2c is located above the first tilt axis T1c and parallel to the first tilt axis T1c. In addition, the second tilt axis T2c is orthogonal to the pan axis Pc and the optical axis Oc.

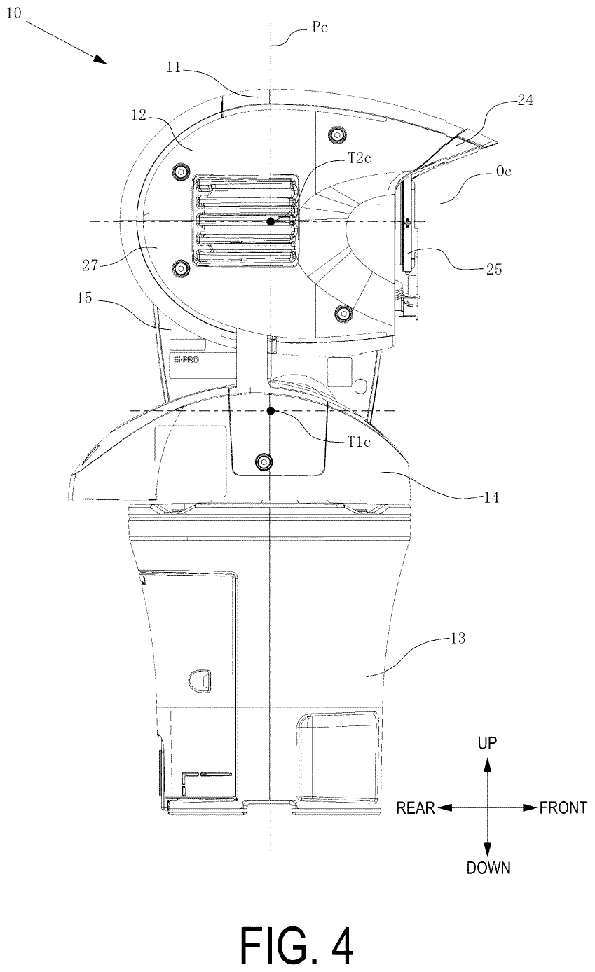

As shown in FIG. 4, the second tilt axis T2c passes through the vicinity of the center of gravity of the camera unit 11, for example. The camera unit 11 is supported by the other end of the support arm 15 at a position spaced apart from the rotary table 14 in the up-down direction. That is, the camera unit 11 is adapted to be rotatable about two axes: the first tilt axis T1c and the second tilt axis T2c. As described above, since the support arm 15 rotates about the first tilt axis T1c, the camera unit 11 can be moved with respect to the rotary table 14 in the front-rear direction. In addition, since the camera unit 11 rotates with respect to the support arm 15 about the second tilt axis T2c, the camera unit 11 can face in the up-down direction.

The imaging unit 21 is disposed at a position where the optical axis Oc of the lens 21A is spaced apart from the second tilt axis T2c and along a direction orthogonal to the second tilt axis T2c. The optical axis Oc is disposed at a position on an opposite side to the first tilt axis T1c with the second tilt axis T2c interposed therebetween. The imaging unit 21 captures a direction of the optical axis Oc. The optical axis Oc is a virtual line passing through a center of an angle of view of the imaging unit 21.

The illumination unit 12 is provided by being connected to the other side surface (left side surface) of the camera unit 11. That is, the illumination unit 12 is adapted to be rotatable about the pan axis Pc integrally with the rotary table 14, the support arm 15, and the camera unit 11. In addition, the illumination unit 12 is adapted to be rotatable about the first tilt axis T1c integrally with the support arm 15 and the camera unit 11. Further, the illumination unit 12 is adapted to be rotatable about the second tilt axis T2c integrally with the camera unit 11.

The illumination unit 12 includes a housing 27, a cover glass 28, and an LED (not shown) incorporated in the housing 27. The LED can irradiate a subject with illumination light corresponding to an imaging angle of view of the imaging unit 21 through the cover glass 28. The housing 27 of the illumination unit 12 is a housing separate from the camera housing 20 of the camera unit 11. Specifically, an inner cover (not shown) constituting the housing 27 of the illumination unit 12 is fixed to the other side surface of the camera housing 20. Therefore, an internal space of the camera housing 20, which accommodates the imaging unit 21, and an internal space of the housing 27, which accommodates the illumination unit 12, are partitioned from each other.

### Configuration of Camera Unit 11

As shown in FIG. 5, the camera unit 11 houses the imaging unit 21 inside the camera housing 20. Note that in FIG. 5, the shielding portion 24 and the wiper 25 are not shown. The imaging unit 21 is fixed to the camera housing 20. The cover unit 22 is attached to a contact portions 34 of the camera housing 20 by screws 29 (first screw) extending in the front-rear direction, that is, the direction of the optical axis Oc. The contact portions 34 is formed on a front surface 20A of the camera housing 20 (a surface of the imaging unit 21 on the subject side).

### Configuration of Camera Housing 20

The front surface 20A is a flat surface orthogonal to the optical axis Oc. In addition, the front surface 20A is a surface that is exposed to the outside (becomes an outer surface of the camera housing 20) when the cover unit 22 is removed. The front surface 20A faces a contact surface 55 of the cover unit 22, which will be described below. Further, the contact portions 34 formed on the front surface 20A comes into contact with protruding portions 38 of the cover unit 22, which will be described below.

As shown in FIG. 6, an opening 31, an annular recessed portion 32, an insertion port 33, the contact portions 34, and positioning pins 35 are formed on the front surface 20A of the camera housing 20. Note that a component of the camera housing 20, which includes the front surface 20A, is made of metal.

The opening 31 penetrates through the front surface 20A in a thickness direction (front-rear direction). In other words, the front surface 20A is a surface surrounding the opening 31. In addition, the lens 21A of the imaging unit 21 is exposed to the front side (subject side) through the opening 31.

The annular recessed portion 32 is formed at a position surrounding the opening 31 and the insertion port 33. The annular recessed portion 32 is a space defined by a bottom surface 32A, an outer peripheral surface 32B, and an inner peripheral surface 32C. The bottom surface 32A is a surface that recedes rearward (toward the imaging unit 21) from the front surface 20A and is parallel to the front surface 20A. In addition, the bottom surface 32A is formed in an annular shape. The outer peripheral surface 32B and the inner peripheral surface 32C are surfaces intersecting (orthogonal to) the front surface 20A and the bottom surface 32A. The outer peripheral surface 32B connects the front surface 20A and the bottom surface 32A on an outer periphery side of the annular bottom surface 32A. The inner peripheral surface 32C connects the front surface 20A and the bottom surface 32A on an inner periphery side of the annular bottom surface 32A. The annular recessed portion 32 is formed over the entire circumference around the opening 31 and the insertion port 33. A plurality of positioning pins 32D are provided on the bottom surface 32A of the annular recessed portion 32. The positioning pins 32D is formed in a cylindrical shape. The positioning pins 32D protrudes forward (toward the subject side).

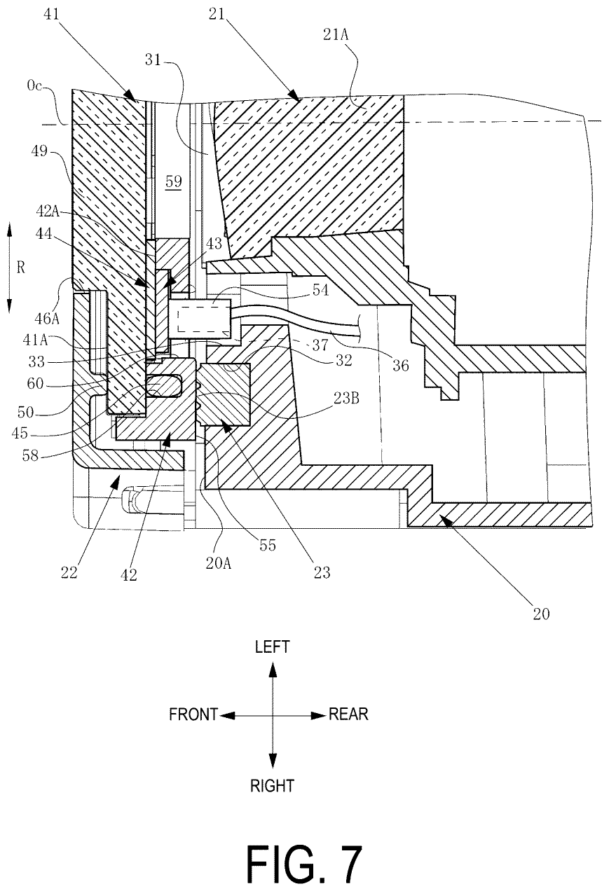

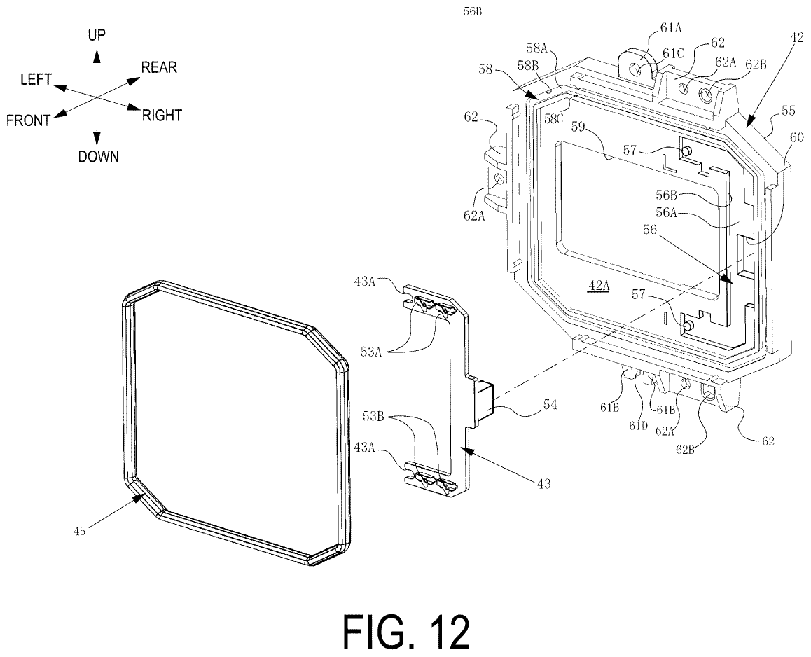

The insertion port 33 is a through hole connecting to the opening 31 and penetrating through the bottom surface 32A forming the annular recessed portion 32 in the thickness direction. The insertion port 33 is provided on an outer side in a radial direction R with respect to the opening 31. Note that in the present specification, a radial direction of the opening 31, which is a direction orthogonal to the optical axis Oc and has the optical axis Oc as a central axis, is referred to as a “radial direction R”. In addition, a direction from the outer side of the opening 31 toward the central axis (optical axis Oc) in the radial direction R is referred to as an inner side in the radial direction R, and a direction from the central axis toward the outer side of the opening 31 in the radial direction R is referred to an outer side in the radial direction R. In addition, a power supply circuit (not shown) is provided inside the camera housing 20 and is connected to a housing-side connector 37 via a lead wire 36. Note that FIG. 6 shows a state in which the lead wire 36 and the housing-side connector 37 are drawn out from the inside of the camera housing 20. The housing-side connector 37 is connected to a substrate-side connector 54 (see FIG. 12) described below. In addition, the housing-side connector 37 is inserted into the camera housing 20 through the insertion port 33 together with the lead wire 36 and the substrate-side connector 54 (a state shown in FIG. 7). The power supply circuit supplies power to a substrate 43 via the lead wire 36, the housing-side connector 37, and the substrate-side connector 54.

When the camera housing 20 and the imaging unit 21 are viewed from the front (front side), the opening 31 has a circular shape with an inner diameter that is substantially the same as an outer diameter of the imaging unit 21. Therefore, the camera housing 20 has the insertion port 33 formed by expanding a part of the opening 31 toward the outer side in the radial direction R, in order to allow the housing-side connector 37 to be pulled out from a side of the imaging unit 21. Since the insertion port 33 is provided on the side of the opening 31, a gap larger than an outer shape of the housing-side connector 37 is provided between the imaging unit 21 and the camera housing 20. Thus, the housing-side connector 37 can be pulled out from the inside of the camera housing 20 through the gap.

The contact portions 34 is provided on the front surface 20A at a position different from the opening 31. Specifically, a plurality of contact portions 34 are provided at positions on the outer side in the radial direction R with respect to the opening 31. More specifically, the contact portions 34 are disposed at four corners of the front surface 20A. The contact portions 34 protrudes forward from the front surface 20A toward the cover unit 22 side. A female screw hole 34B is formed in a front surface 34A of the contact portions 34 facing the cover unit 22. The front surface 34A of the contact portions 34 is an example of a “surface on the subject side” in the claims. A screw 29 penetrating through the cover unit 22 (an exterior cover 46 described below) in the front-rear direction is screwed into the female screw hole 34B. Thus, the cover unit 22 is fastened to the camera housing 20.

The positioning pins 35 is provided on the front surface 20A. Specifically, the positioning pins 35 is provided on each of an upper side and a lower side of the front surface 20A with the annular recessed portion 32 interposed therebetween. In addition, the positioning pins 35 are preferably formed at a plurality of positions (two positions in the present embodiment) on the front surface 20A. Additionally, the positioning pins 35 is formed in a cylindrical shape. Further, the positioning pins 35 protrudes from the front surface 20A in the front-rear direction parallel to the optical axis Oc.

### Configuration of First Water-Blocking Member 23

The first water-blocking member 23 is formed of an elastic material (for example, rubber) and has an annular outer shape conforming to the annular recessed portion 32. The first water-blocking member 23 is formed with a plurality of positioning holes 23A. The first water-blocking member 23 is positioned in the annular recessed portion 32 by the positioning pins 32D entering the positioning holes 23A.

As shown in FIG. 7, the first water-blocking member 23 accommodated in the annular recessed portion 32 is located on the outer side in the radial direction R with respect to the opening 31 and the insertion port 33. That is, the substrate-side connector 54 protrudes toward the camera housing 20 on the inner side of the first water-blocking member 23 in the radial direction R, is connected to the housing-side connector 37, and is inserted into the insertion port 33. Note that FIG. 7 is a cross-sectional view taken along a plane passing through the optical axis Oc and the substrate-side connector 54, and the radial direction R in the drawing is a direction orthogonal to the optical axis Oc and along a straight line included in the cross-section.

A front surface of the first water-blocking member 23 accommodated in the annular recessed portion 32 protrudes forward of the front surface 20A of the camera housing 20. For this reason, when the cover unit 22 is attached to the camera housing 20 by the screws 29 described above, the first water-blocking member 23 is elastically compressed between the camera housing 20 and the cover unit 22 at a position surrounding the opening 31 over the entire circumference, thereby preventing water from entering the opening 31.

Further, a plurality of vs 23B are formed on the front surface of the first water-blocking member 23. The plurality of first projections 23B are disposed at equal intervals in the radial direction R. In addition, the first projections 23B is continuous in the circumferential direction. Further, the first projections 23B protrudes toward the front cover unit 22 side. More specifically, the first projections 23B is formed at a position overlapping the contact surface 55 of the base member 42 when viewed from the direction of the optical axis Oc. Therefore, when the cover unit 22 is attached to the camera housing 20 with the screws 29, the first projections 23B are pressed and crushed by elastic compression at positions surrounding the opening 31 over the entire circumference.

### Configuration of Cover Unit 22

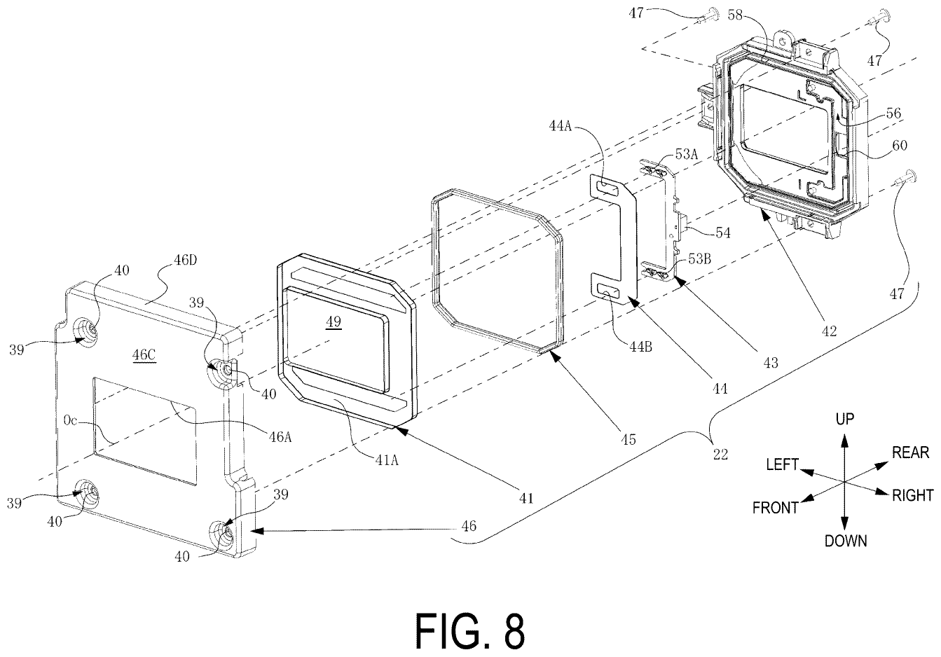

As shown in FIG. 8, the cover unit 22 includes a cover glass 41, a base member 42, a substrate 43, a pressing sheet 44, a second water-blocking member 45, an exterior cover 46, and screws 47 (second screw). The components (41 to 47) of the cover unit 22 are laminated in the direction of the optical axis Oc. That is, the laminating direction of the components (41 to 47) of the cover unit 22 coincides with the optical axis Oc. The base member 42 and the exterior cover 46 are resin components.

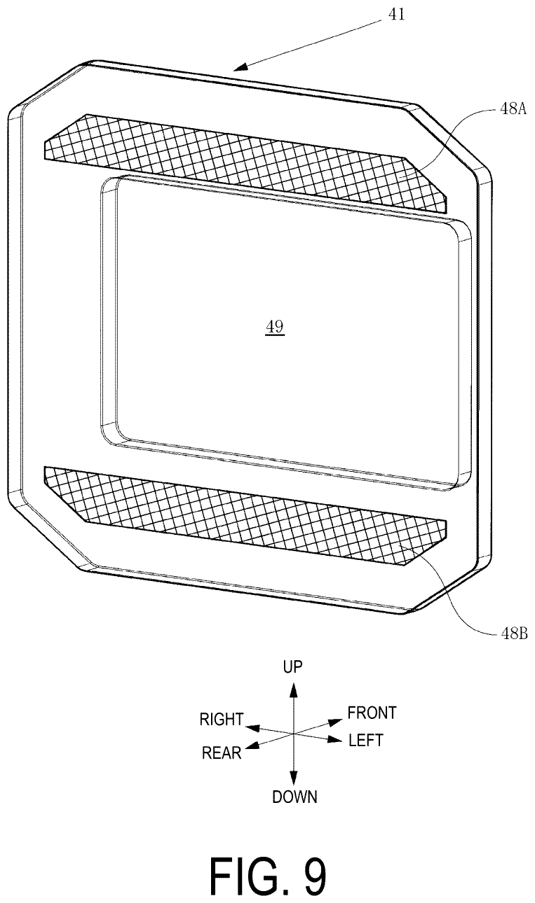

As shown in FIG. 9, the cover glass 41 is formed of glass having transparency to transmit light. The cover glass 41 has a substantially plate-like outer shape. An external exposed portion 49 (see FIGS. 7, 8, and 14) is formed substantially at the center of the cover glass 41. The cover glass 41 is positioned on a rear surface side (imaging unit 21 side) of the exterior cover 46. In addition, the cover glass 41 has a contact surface 41A that comes into contact with a second projection 50 of the exterior cover 46 described below (see FIGS. 7, 8, and 14).

The external exposed portion 49 is a portion protruding forward of the contact surface 41A. In addition, the external exposed portion 49 is a portion facing the opening 31 (more specifically, the lens 21A of the imaging unit 21) in the direction of the optical axis Oc. Further, the external exposed portion 49 is a portion exposed to the outside through an opening 46A of the exterior cover 46, which will be described below.

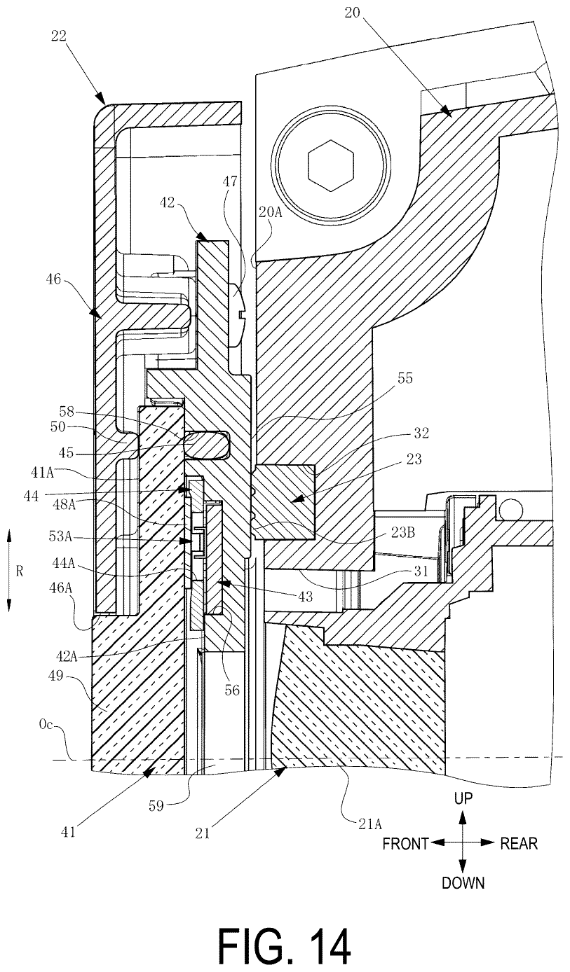

In addition, the cover glass 41 includes a transparent conductive film (not shown) and a pair of electrodes 48A and 48B. The transparent conductive film is a conductive thin film formed by vapor deposition on the rear surface (the surface on the imaging unit 21 side) of the cover glass 41. The electrodes 48A and 48B are a pair of electrodes located on the outer side in the radial direction R with respect to the external exposed portion 49. The electrodes 48A and 48B are formed while being laminated on the transparent conductive film (see FIG. 14). A length of each of the electrodes 48A and 48B in the left-right direction is preferably set to be longer than an entire length of each of the upper and lower sides of the external exposed portion 49. The electrodes 48A and 48B are preferably made of metal with high conductivity and are formed by gold plating, for example.

When power is supplied to the cover glass 41 from the substrate 43 via contact terminals 53A and 53B described below, the transparent conductive film is energized through the electrodes 48A and 48B, and heat is generated due to electrical resistance of the transparent conductive film. Thus, freezing and fogging on the cover glass 41 can be prevented. That is, the substrate 43, the electrodes 48A and 48B, and the transparent conductive film constitute a heater that removes fogging on the cover glass.

The exterior cover 46 covers the front surface side of the cover glass 41. In other words, the exterior cover 46 is disposed on a side opposite to the base member 42 with the cover glass 41, the substrate 43, the pressing sheet 44, and the second water-blocking member 45 interposed therebetween. The exterior cover 46 is composed of, for example, a main wall 46C and a tubular wall 46D. The main wall 46C is a flat plate-shaped portion orthogonal to the optical axis Oc. The tubular wall 46D is a portion that protrudes rearward from an outer edge of the main wall 46C and is continuous in the circumferential direction.

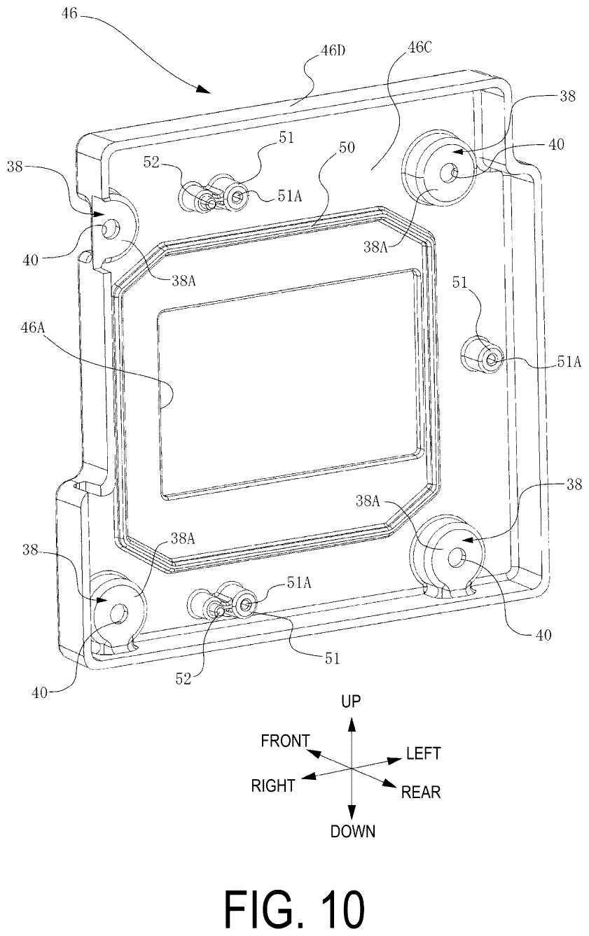

As shown in FIG. 10, an opening 46A penetrating in the thickness direction is formed at the center of the main wall 46C of the exterior cover 46. When the exterior cover 46 and the cover glass 41 are combined, the external exposed portion 49 can be exposed to the outside from the opening 46A. The main wall 46C of the exterior cover 46 is formed to have a substantially quadrangular outer shape in conformity with the front surface 20A of the camera housing 20.

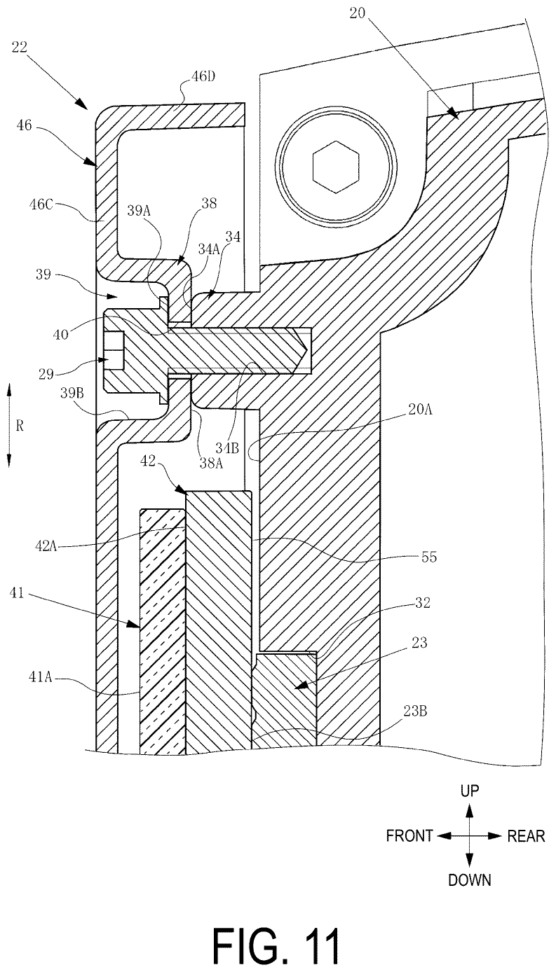

As shown in FIG. 11, protruding portions 38 and recessed portions 39 are formed on the main wall 46C. The protruding portions 38 and the recessed portions 39 are located on the outer side in the radial direction R with respect to the cover glass 41 and the base member 42. The protruding portions 38 and the recessed portions 39 are disposed at four corners of the main wall 46C. Note that FIG. 11 is a cross-sectional view taken along a plane passing through the contact portions 34, the protruding portions 38, the recessed portions 39, and the screw 29, and the radial direction R in the drawing is a direction orthogonal to the optical axis Oc and along a straight line included in the cross-section.

The recessed portions 39 is a space recessed rearward from the front surface of the main wall 46C. Specifically, the recessed portions 39 is a space defined by a bottom surface 39A and a peripheral surface 39B. The bottom surface 39A is a surface that is recessed from the front surface of the main wall 46C toward the camera housing 20 side and is parallel to the front surface of the main wall 46C. The peripheral surface 39B surrounds the bottom surface 39A and connects the front surface of the main wall 46C and the bottom surface 39A. A through hole 40 is formed in the bottom surface 39A. The screw 29 (see FIG. 5) is inserted into the through hole 40. A head portion of the screw 29 inserted into the through hole 40 is accommodated in the recessed portions 39.

The protruding portions 38 is formed on the rear surface side of the main wall 46C (a side facing the camera housing 20). The protruding portions 38 are disposed at positions opposite to the recessed portions 39 in the thickness direction of the main wall 46C. The protruding portions 38 protrudes rearward from the rear surface of the main wall 46C. Of the protruding portions 38, a rear surface 38A facing the camera housing 20 is in contact with the front surface 34A of the contact portions 34 described above. The through hole 40 penetrates from the bottom surface 39A of the recessed portions 39 to the rear surface 38A of the protruding portions 38.

By positioning the camera housing 20 and the exterior cover 46, which will be described below, the rear surface 38A of the protruding portions 38 comes into contact with the front surface 34A of the contact portions 34. In other words, by the positioning described above, the through hole 40 of the exterior cover 46 and the female screw hole 34B of the camera housing 20 communicate with each other. The screw 29 inserted into the through hole 40 is screwed into the female screw hole 34B of the contact portions 34. Thus, the exterior cover 46 is attached to the camera housing 20. Below, the fastening by the screw 29 for attaching the exterior cover 46 to the camera housing 20 is referred to as “first fastening”.

In addition to the protruding portions 38, a second projection 50, protrusions 51, and positioning pins 52 are formed on the rear surface side of the exterior cover 46. The second projection 50 is continuous in the circumferential direction at a position surrounding the opening 46A. In addition, the second projection 50 is an annular projection protruding rearward toward the cover glass 41 side. When viewed from the direction of the optical axis Oc, the second projection 50 is formed at a position overlapping an annular recessed portion 58 of the base member 42 described below (see FIGS. 7 and 14). That is, the second projection 50 is formed at a position overlapping the second water-blocking member 45 disposed in the annular recessed portion 58 when viewed from the direction of the optical axis Oc.

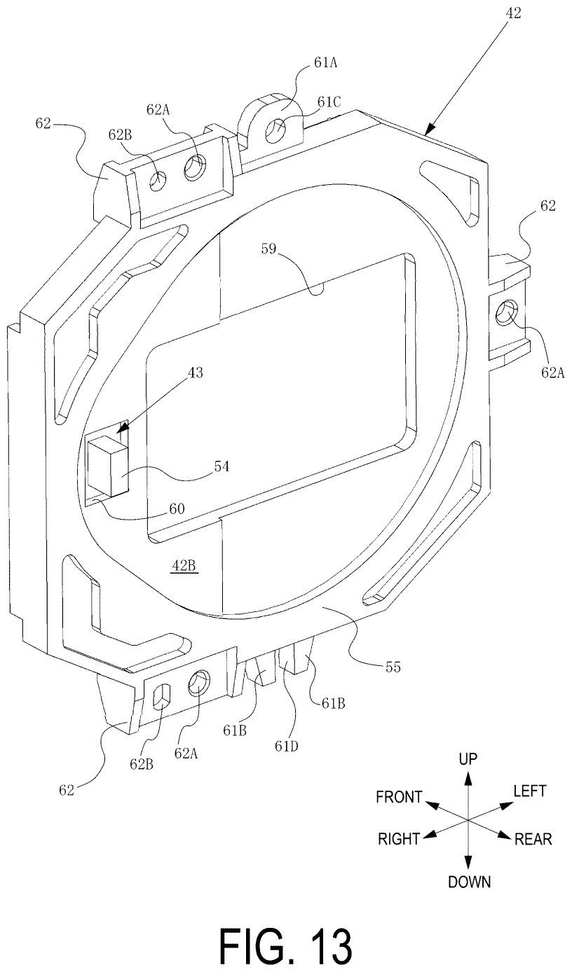

The protrusions 51 are formed at a plurality of positions on the outer side in the radial direction R with respect to the second projection 50. A female screw hole 51A for screwing a screw 47 described below is formed in the protrusions 51. The protrusions 51 protrudes rearward from the rear surface of the main wall 46C toward the base member 42 side. The screw 47 (see FIG. 8) passing through a through hole 62A (see FIGS. 12 and 13) of the base member 42 is screwed into the female screw hole 51A. Thus, the base member 42 and the exterior cover 46 are fastened to each other with the cover glass 41, the substrate 43, the pressing sheet 44, and the second water-blocking member 45 interposed therebetween. That is, the components (41 to 47) of the cover unit 22 are laminated and integrated in the direction of the optical axis Oc. The screw 47 screwed into the female screw hole 51A extends in the direction of the optical axis Oc (the laminating direction of the components (41 to 47) of the cover unit 22).

The positioning pins 52 are formed at a plurality of positions on the outer side in the radial direction with respect to the second projection 50. The positioning pins 52 protrudes rearward from the rear surface of the main wall 46C. When the cover unit 22 is assembled, the positioning pins 52 enters a positioning hole 62B of the base member 42. Thus, the base member 42 and the exterior cover 46 are positioned with each other.

As shown in FIGS. 12 and 13, the outer shape of the substrate 43 viewed from the direction of the optical axis Oc is formed in a U-shape. The substrate 43 is provided with contact terminals 53A and 53B and a substrate-side connector 54. In addition, positioning grooves 43A are formed at both end portions of the substrate 43. The substrate 43 is a double-sided substrate having both surfaces on which components can be mounted. The contact terminals 53A and 53B are mounted on the front surface side of the substrate 43 facing the cover glass 41. On the other hand, the substrate-side connector 54 is mounted on the rear surface side of the substrate 43. The contact terminals 53A and 53B are electrically connected to the substrate-side connector 54.

The substrate-side connector 54 protrudes toward the rear surface side of the base member 42 through a through hole 60 (see FIGS. 8 and 13) formed in the base member 42 and is connected to the housing-side connector 37 (see FIG. 6). Thus, the substrate 43 is electrically connected to the power supply circuit provided inside the camera housing 20. The substrate 43 can supply power to the cover glass 41 by being electrically connected to the cover glass 41.

The contact terminals 53A and 53B are disposed in alignment with the positions of the electrodes 48A and 48B of the cover glass 41, respectively. That is, the contact terminals 53A and 53B are positioned outward of the external exposed portion 49 of the cover glass 41 and inward of the second water-blocking member 45 in the radial direction R (see FIG. 14). Note that in the example shown in FIG. 12, two contact terminals 53A, 53B corresponding to each of the electrodes 48A and 48B, i.e., four contact terminals in total, are provided. However, the present invention is not limited thereto, and one contact terminal may be provided for each of the electrodes 48A and 48B.

The cover glass 41 and the substrate 43 are electrically connected to each other as the contact terminals 53A and 53B come into contact with the electrodes 48A and 48B. The contact terminals 53A and 53B are formed by bending a metal plate and are leaf spring-like contact terminals with elasticity. Note that the contact terminals 53A and 53B are not limited to those described above, but may be any terminals as long as they have elasticity and can make pressure contact with the electrodes 48A and 48B. By fastening the base member 42 and the exterior cover 46 with the screws 47, the contact terminals 53A and 53B are elastically compressed in the direction of the optical axis Oc and are thus brought into pressure contact with the electrodes 48A and 48B.

The base member 42 is a plate-like member having a substantially quadrangular outer shape smaller than the exterior cover 46. The base member 42 has a substrate mounting recessed portion 56, positioning pins 57, and an annular recessed portion 58 formed on the front surface 42A side facing the cover glass 41.

An opening 59 penetrating in the thickness direction is formed at the center of the base member 42. The opening 59 is formed in accordance with the position and size of the external exposed portion 49 of the cover glass 41. The opening 59 allows light exposed through the external exposed portion 49 of the cover glass 41 to reach the lens 21A of the imaging unit 21.

The substrate mounting recessed portion 56 is formed at a position on the inner side in the radial direction with respect to the annular recessed portion 58, avoiding the opening 59. The substrate mounting recessed portion 56 is a space recessed rearward from the front surface 42A of the base member 42. Specifically, the substrate mounting recessed portion 56 is a space defined by a bottom surface 56A and a peripheral surface 56B. The bottom surface 56A is a surface that recedes from the front surface 42A toward the camera housing 20 side and is parallel to the front surface 42A. The bottom surface 56A is formed in a U-shape in conformity with the outer shape of the substrate 43. The peripheral surface 56B is a surface intersecting (orthogonal to) the front surface 42A and the bottom surface 56A. The peripheral surface 56B surrounds the U-shaped bottom surface 56A and connects the front surface 42A and the bottom surface 56A. The substrate mounting recessed portion 56 houses the substrate 43 therein.

The positioning pins 57 is formed in a cylindrical shape protruding from the bottom surface 56A toward the cover glass 41 side. The positioning pins 57 enters the positioning groove 43A of the substrate 43 accommodated in the substrate mounting recessed portion 56. Thus, the substrate 43 is positioned with respect to the base member 42.

A through hole 60 (see FIGS. 8 and 13) penetrating through the base member 42 in the thickness direction is formed at a central portion of the bottom surface 56A. The through hole 60 extends from the bottom surface 56A of the substrate mounting recessed portion 56 to the rear surface 42B side of the base member 42 (the side facing the camera housing 20). When the substrate 43 is accommodated in the substrate mounting recessed portion 56, the substrate-side connector 54 passes through the through hole 60 and protrudes toward the rear surface side of the cover unit 22 (the side facing the camera housing 20).

The annular recessed portion 58 is formed at a position surrounding the opening 59 and the substrate mounting recessed portion 56. In addition, the annular recessed portion 58 is a space defined by a bottom surface 58A, an outer peripheral surface 58B, and an inner peripheral surface 58C. The bottom surface 58A is a surface that recedes from the front surface 42A toward the camera housing 20 side and is parallel to the front surface 42A. The bottom surface 58A is formed in an annular shape. The outer peripheral surface 58B and the inner peripheral surface 58C are surfaces intersecting (orthogonal to) the front surface 42A and the bottom surface 58A. The outer peripheral surface 58B is continuous with the outer periphery of the bottom surface 58A on the outer periphery side of the annular bottom surface 58A and is disposed along the outer edge of the base member 42. The inner peripheral surface 58C is connected to the bottom surface 56A on the inner periphery side of the annular bottom surface 56A. The second water-blocking member 45 is accommodated in the annular recessed portion 58.

Positioning portions 61A and 61B are formed at two locations of an outer edge portion of the base member 42. The positioning portions 61A and 61B protrude in the up-down direction from the substantially quadrangular outer shape of the base member 42. The positioning pins 35 of the camera housing 20 can be inserted into the positioning portions 61A and 61B. Thus, the base member 42 (the cover unit 22) can be positioned with respect to the camera housing 20. As a more specific configuration, the positioning portion 61A is a surface protruding upward from the outer shape of the base member 42. In addition, a through hole 61C is formed at the center of the positioning portion 61A. The positioning portion 61B is composed of two projections protruding downward from the outer shape of the base member 42. The two projections are spaced apart from each other. The positioning pins 35 of the camera housing 20 enter the through hole 61C of the positioning portion 61A and a space 61D between the projections of the positioning portion 61B. Note that since an end portion of the space 61D between the projections is opened, the positioning pins 35 can be easily hooked at the time of positioning. However, the present invention is not limited thereto, and the positioning portion may be formed on the camera housing 20 and the positioning pin may be formed on the cover unit 22.

In addition, fastening portions 62 are formed at three locations on the outer edge portion of the base member 42. The fastening portions 62 protrude in the up-down direction and the left direction from the substantially quadrangular outer shape of the base member 42. One or both of a through hole 62A and a positioning hole 62B are formed in the fastening portions 62. The screw 47 is inserted into the through hole 62A. The positioning pins 52 of the exterior cover 46 enters the positioning hole 62B. Thus, the base member 42 is positioned with respect to the exterior cover 46. In addition, the screw 47 inserted into the through hole 62A is screwed into the female screw hole 51A of the exterior cover 46. Thus, the base member 42 and the exterior cover 46 are fastened to each other. Below, the fastening of the base member 42 with the exterior cover 46 by the screw 47 is referred to as “second fastening”.

Further, as shown in FIGS. 7, 13, and 14, the rear surface 42B of the base member 42 is formed with a contact surface 55. The contact surface 55 is a surface formed at a position surrounding the opening 59 and the through hole 60. In addition, the contact surface 55 is a flat surface orthogonal to the direction of the optical axis Oc. Furthermore, the contact surface 55 is a surface that comes into contact with the first water-blocking member 23 when the cover unit 22 is attached to the camera housing 20.

As shown in FIG. 14, the first projections 23B of the first water-blocking member 23 is pressed against the contact surface 55 by the first fastening of the exterior cover 46 to the camera housing 20. As a result, the first water-blocking member 23 including the first projections 23B is elastically compressed and comes into pressure contact with the base member 42. Note that FIG. 14 is a cross-sectional view taken along a plane passing through the optical axis Oc and the electrodes 48A and 48B, and the radial direction R in the drawing is a direction orthogonal to the optical axis Oc and along a straight line included in the cross-section. As described above, the front surface of the first water-blocking member 23 protrudes forward of the front surface 20A of the camera housing 20. Due to the elastic compression of the first water-blocking member 23, the base member 42 and the camera housing 20 move in a direction of approaching each other, but a clearance is formed between the contact surface 55 and the front surface 20A of the camera housing 20.

Note that although the annular first projections 23B provided on the first water-blocking member 23 is pressed against the base member 42 by the first fastening in the present embodiment, the present invention is not limited to this configuration, and the first water-blocking member 23 may be elastically compressed to be in pressure contact with the base member 42 and the annular projection provided on the base member 42 may be pressed against the first water-blocking member 23 by the first fastening.

The pressing sheet 44 is a sheet-like member having substantially the same outer shape as that of the substrate 43. The pressing sheet 44 is formed with opening portions 44A and 44B penetrating in the thickness direction (see FIG. 8). The opening portions 44A and 44B are disposed in alignment with the positions of the contact terminals 53A and 53B so that the pressing sheet 44 does not interfere with the contact between the contact terminals 53A and 53B and the electrodes 48A and 48B. The pressing sheet 44 is disposed between the cover glass 41 and the substrate 43. A gap between the cover glass 41 and the substrate 43 is designed to be equal to or less than a thickness of the pressing sheet 44. That is, when the exterior cover 46 and the base member 42 are fastened by the second fastening, the pressing sheet 44 is elastically compressed to position the substrate 43 in the substrate mounting recessed portion 56.

The second water-blocking member 45 is formed of an elastic material (for example, rubber). In addition, the second water-blocking member 45 is formed in an annular shape that is continuous in the circumferential direction. The second water-blocking member 45 is fitted into the annular recessed portion 58 of the base member 42. Accordingly, the second water-blocking member 45 is disposed at a position surrounding the opening 59 and the substrate mounting recessed portion 56, that is, at a position surrounding the heater (the substrate 43, the electrodes 48A and 48B, and the transparent conductive film) over the entire circumference. The second water-blocking member 45 is sandwiched between the base member 42 and the cover glass 41. The second water-blocking member 45 is elastically compressed between the base member 42 and the cover glass 41.

Note that the configuration of the second water-blocking member 45 is not limited to that described above, and may be any configuration as long as the second water-blocking member 45 is disposed over the entire circumference around the opening 59 and the substrate mounting recessed portion 56 and is sandwiched between the base member 42 and the cover glass 41. For example, an adhesive with elasticity may be used as the second water-blocking member 45, and may be applied between the base member 42 and the cover glass 41 over the entire circumference around the opening 59 and the substrate mounting recessed portion 56.

In addition, as described above, the second projection 50 is formed on the exterior cover 46 at a position overlapping the annular recessed portion 58 (the second water-blocking member 45) when viewed from the direction of the optical axis Oc. Thus, when the exterior cover 46 and the base member 42 are fastened by the second fastening, the second projection 50 presses the second water-blocking member 45 via the cover glass 41.

### Assembling Process of Camera Unit 11

Next, a process of assembling the camera unit 11 will be described. First, the exterior cover 46 and the base member 42 are joined by the second fastening to integrate the cover unit 22. That is, the exterior cover 46 and the base member 42 are joined by the second fastening in a state where the cover glass 41 is disposed on the rear surface side of the exterior cover 46, the substrate 43 is accommodated in the substrate mounting recessed portion 56 of the base member 42, the pressing sheet 44 is disposed between the cover glass 41 and the substrate 43, the second water-blocking member 45 is fitted into the annular recessed portion 58, and the positioning pins 52 is inserted into the positioning hole 62B.

Thus, the components (41 to 47) of the cover unit 22 are laminated in the direction of the optical axis Oc. Then, the external exposed portion 49 is exposed from the opening 59, the contact terminals 53A and 53B and the electrodes 48A and 48B are electrically connected to each other, and the cover glass 41 and the base member 42 are sealed against water ingress by the second water-blocking member 45.

In addition, the substrate-side connector 54 and the housing-side connector 37 are connected to each other to electrically connect the substrate 43 and the power supply circuit. Additionally, the first water-blocking member 23 is disposed in the annular recessed portion 32 of the camera housing 20. Next, the contact surface 55 of the base member 42 is caused to face the front surface 20A of the camera housing 20, and the positioning pins 35 of the camera housing 20 are caused to enter the positioning portions 61A and 61B of the base member 42. Thus, the cover unit 22 is positioned with respect to the camera housing 20. Specifically, first, the positioning pins 35 on the lower side of the camera housing 20 is caused to enter the space 61D between the two projections from below the positioning portion 61B of the base member 42. Thus, the position of the base member 42 in the left-right direction with respect to the camera housing 20 is fixed.

After the position of the base member 42 in the left-right direction is fixed, the positioning pins 35 on the upper side of the camera housing 20 is caused to enter the through hole 61C of the positioning portion 61A. Thus, the through hole 61C is engaged with the positioning pins 35. As such, the position of the base member 42 in the left-right direction and the up-down direction is fixed, and the base member 42 can be positioned with respect to the camera housing 20. Specifically, the rear surface 38A of the protruding portions 38 of the exterior cover 46 and the front surface 34A of the contact portions 34 of the camera housing 20 come into contact with each other. Thus, it is possible to position the exterior cover 46 in the front-rear direction with respect to the camera housing 20. At the same time, the through hole 40 of the exterior cover 46 and the female screw hole 34B of the camera housing 20 communicate with each other.

Further, the cover unit 22 is fastened to the camera housing 20 by the first fastening. That is, the screw 29 inserted into the through hole 40 is screwed into the female screw hole 34B. Thus, the cover unit 22 is attached to the camera housing 20 such that the external exposed portion 49 of the cover glass 41 covers the lens 21A of the imaging unit 21. In addition, during the second fastening, the substrate-side connector 54 is inserted into the insertion port 33. Note that the cover unit 22 (more specifically, the exterior cover 46) attached to the camera housing 20 constitutes an outer surface of the camera unit 11.

### Advantageous Effects of Embodiment

According to the above-described embodiment, the cover unit 22 including the cover glass 41 with the heater and the exterior cover 46 is brought into contact with a surface of the camera housing 20 on a subject side, so that a replacement operation of the cover unit 22 can be easily performed. In addition, the exterior cover 46, which covers the subject side of the cover glass 41, of the cover unit 22 is brought into contact with the contact portions 34. As a result, the exterior cover 46 can be positioned in the front-rear direction with respect to the camera housing 20, so the cover unit 22 can be easily attached to the camera housing 20. Therefore, the replacement operation of the cover unit 22 is further facilitated. In addition, since the exterior cover 46, which is a member fixed to the camera housing 20, of the cover unit 22 is positioned in the front-rear direction with respect to the camera housing 20, there is no rattling between components, and the attachment accuracy of the cover unit 22 with respect to the camera housing 20 is improved.

In addition, as the positioning protruding portions provided on one of the cover unit 22 and the camera housing 20 enters the positioning recessed portion provided on the other, the cover unit 22 is positioned with respect to the camera housing 20 in the up-down direction and the left-right direction. Therefore, the positioning step of the cover unit 22 can be easily performed, and the replacement operation of the cover unit 22 is further facilitated.

In addition, as the positioning step of the cover unit 22 with respect to the camera housing 20 is performed as described above, the contact portions 34 comes into contact with the protruding portions 38 protruding from the exterior cover 46 toward the camera housing 20. Therefore, it is possible to arrange a fastening space (a space into which the screw 29 is screwed in the present embodiment) at the positions of the contact portions 34 and the protruding portions 38. Thus, the camera housing 20 and the cover unit 22 can be securely fastened to each other.

In addition, since the surveillance camera 10 includes the annular first water-blocking member 23 that is elastically compressed between the camera housing 20 and the base member 42, even if water enters between the camera housing 20 and the base member 42 from the outside, it is possible to prevent water from entering further inside than the first water-blocking member 23. In addition, since the first water-blocking member 23 is elastically compressed between the camera housing 20 and the base member 42 at the position surrounding the opening 31 over the entire circumference, it is possible to prevent water from entering the inside of the camera housing 20 from the opening 31.

In addition, since one of the first water-blocking member 23 and the base member 42 has the annular first projections 23B that is pressed against the other, the first water-blocking member 23 is elastically compressed and comes into pressure contact with the base member 42. As a result, the first water-blocking member 23 and the base member 42 are more strongly brought into close contact with each other, and thus it is possible to reliably prevent water from entering further inside than the first water-blocking member 23.

In addition, the cover unit 22 is fastened to the camera housing 20 with the screws 29 extending in the laminating direction of the components (41 to 47), thereby elastically compressing the first water-blocking member 23. That is, since the direction in which the base member 42 is pressed against the first water-blocking member 23 by the fastening of the screws 29 and the direction in which the first water-blocking member 23 is elastically compressed coincide with each other, the force with which the base member 42 is pressed by the fastening of the screws 29 is easily transmitted to the first water-blocking member 23, and thus the base member 42 and the first water-blocking member 23 are further strongly brought into close contact with each other.

In addition, in a state where the cover unit 22 is positioned with respect to the camera housing 20 in the up-down direction, the left-right direction, and the front-rear direction as described above, since the through hole 40 for fastening and the female screw hole 34B communicate with each other, it is possible to easily screw the screw 29 inserted into the through hole 40 into the female screw hole 34B. Therefore, the replacement operation of the cover unit 22 is further facilitated.

In addition, the heater (the substrate 43, the electrodes 48A and 48B, and the transparent conductive film) includes the substrate-side connector 54 inserted into the insertion port 33 provided on the camera housing 20, and the substrate-side connector 54 protrudes toward the camera housing 20 on the inner side of the first water-blocking member 23. Thus, water can be prevented from entering the position of the substrate-side connector 54. That is, it is possible to maintain the electrical connection between the substrate-side connector 54 and the camera housing 20 side, and to prevent a failure or the like caused by water ingress.

Since the cover unit 22 includes the annular second water-blocking member 45 that is elastically compressed between the cover glass 41 and the base member 42, even if water enters the inside of the cover unit 22 from the clearance between the cover unit 22 and the camera housing 20 or the opening 46A of the exterior cover 46, it is possible to prevent water from entering a position located further inside than the second water-blocking member 45. In addition, since the second water-blocking member 45 is disposed at a position surrounding the heater (the substrate 43, the electrodes 48A and 48B, and the transparent conductive film) over the entire circumference, water entering the inside of the cover unit 22 does not reach the components of the heater. That is, a failure of the heater can be prevented.

In addition, the second water-blocking member 45 is elastically compressed by fastening the base member 42 and the exterior cover 46 with the screws 47. In addition, the direction in which the cover glass 41 and the base member 42 are pressed against the second water-blocking member 45 by the fastening of the screws 47 coincides with the direction in which the second water-blocking member 45 is elastically compressed. As a result, the force with which the cover glass 41 and the base member 42 are pressed by the fastening of the screws 47 is easily transmitted to the second water-blocking member 45, and thus the second water-blocking member 45 is strongly brought into close contact with the cover glass 41 and the base member 42. That is, the waterproof effect by the second water-blocking member 45 can be enhanced.

In addition, the exterior cover 46 has the annular second projection 50 protruding toward the cover glass 41. Since the second projection 50 presses the cover glass 41 against the second water-blocking member 45, the force of the exterior cover 46 pressing the cover glass 41 by the fastening of the screws 47 is easily transmitted to the second water-blocking member 45. As a result, the second water-blocking member 45 is more strongly brought into close contact with the cover glass 41 and the base member 42, thereby improving the waterproofness.

In addition, the base member 42 and the exterior cover 46 are fastened to each other by the screws 47, whereby the contact terminals 53A and 53B provided on the substrate 43 and the electrodes 48A and 48B of the cover glass 41 are electrically connected to each other. Since the contact terminals 53A and 53B and the electrodes 48A and 48B are disposed on the inner side of the second water-blocking member 45, it is possible to prevent water from entering the positions of the contact terminals 53A and 53B and the electrodes 48A and 48B. That is, it is possible to maintain the electrical connection between the cover glass 41 and the substrate 43, and to prevent a failure or the like caused by water ingress. In addition, the contact terminals 53A and 53B have elasticity and are pressed against the electrodes 48A and 48B by fastening of the screws 47. That is, the electrical connection between the cover glass 41 and the substrate 43 is reliably maintained by the waterproof effect of the second water-blocking member 45 and the pressure contact of the contact terminals 53A and 53B.

In addition, the cover glass 41 is sandwiched between the exterior cover 46 and the base member 42 by the second fastening. That is, the transparent conductive film and the electrodes 48A and 48B serving as heat sources for heating the cover glass 41 are surrounded by the exterior cover 46 and the base member 42. Thus, heat generated in the transparent conductive film and the electrodes 48A and 48B and conducted to the cover glass 41 is less likely to flow out to the outside. In addition, the component including the front surface 20A of the camera housing 20 is formed of metal with high thermal conductivity, and the exterior cover 46 and the base member 42 are formed of resins with lower thermal conductivity than metal. As a result, even if the temperature of the camera housing 20 decreases due to the influence of the surroundings, the heat of the cover unit 22 is less likely to flow to the camera housing 20 side. As a result, the transparent conductive film and the electrodes 48A and 48B can be kept at a certain temperature or higher, and the effect of preventing freezing and fogging on the cover glass 41 can be maintained.

The above-described embodiments are examples for describing the present invention, and are not intended to limit the scope of the present invention only to these embodiments. One skilled in the art can make appropriate changes without departing from the gist of the present invention.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. An imaging apparatus comprising:
an imaging unit configured to capture a subject;
a camera housing having an opening through which the imaging unit accommodated inside the camera housing is exposed toward a subject side; and
a cover unit in which a cover glass configured to transmit light, a heater configured to remove fogging on the cover glass, a base member disposed on an opposite side to the cover glass with the heater interposed therebetween, and an exterior cover configured to cover the subject side of the cover glass are laminated, wherein
the cover unit is attached to the camera housing by covering the opening with the cover glass and bringing the exterior cover into contact with a surface of the camera housing on the subject side.

2. The imaging apparatus according to claim 1, wherein the cover unit is positioned with respect to the camera housing in up-down and left-right directions by inserting positioning pins provided on one of the cover unit and the camera housing into a positioning portion provided on the other.

3. The imaging apparatus according to claim 2, wherein
the camera housing includes a plurality of contact portions protruding from the surface on the subject side toward the cover unit,
the exterior cover includes a plurality of protruding portions protruding toward the camera housing, and
the cover unit is positioned with respect to the camera housing in a front-rear direction by bringing the protruding portions and the contact portions of the exterior cover and the camera housing into contact with each other.

4. The imaging apparatus according to claim 2, further comprising:
an annular first water-blocking member that is elastically compressed between the camera housing and the base member at a position surrounding the opening over an entire circumference.

5. The imaging apparatus according to claim 4, wherein one of the first water-blocking member and the base member has a first projection that has an annular shape and is pressed against the other.

6. The imaging apparatus according to claim 4, wherein the cover unit elastically compresses the first water-blocking member by being fastened to the camera housing with a first screw extending in a laminating direction of a component of the cover unit.

7. The imaging apparatus according to claim 3, wherein
the cover unit is fastened to the camera housing by a first screw extending in a laminating direction of a component of the cover unit,
the contact portions has a female screw hole in a surface facing the cover unit, the female screw hole being screwed with the first screw,
the exterior cover has a through hole into which the first screw is inserted at a position where the contact portions comes into contact with the exterior cover, and
the through hole and the female screw hole communicate with each other in a state where the exterior cover and the camera housing are positioned in the up-down direction, the left-right direction, and the front-rear direction.

8. The imaging apparatus according to claim 4, wherein the heater includes a connector protruding toward the camera housing on an inner side of the first water-blocking member and inserted into an insertion port provided on the camera housing.

9. The imaging apparatus according to claim 5, wherein the cover unit includes a second water-blocking member that has an annular shape and is elastically compressed between the cover glass and the base member at a position surrounding the heater over an entire circumference.

10. The imaging apparatus according to claim 9, wherein
the base member elastically compresses the second water-blocking member by being fastened to the exterior cover with a second screw extending in a laminating direction of a component of the cover unit.

11. The imaging apparatus according to claim 10, wherein
the exterior cover includes a second projection with an annular shape, the second projection protruding toward the cover glass and pressing the cover glass against the second water-blocking member at a position overlapping the second water-blocking member when viewed from the laminating direction.

12. The imaging apparatus according to claim 10, wherein
the heater includes:
an electrode provided on the cover glass, and
a substrate including a contact terminal with elasticity, and
the contact terminal is brought into pressure contact with the electrode by fastening the base member and the exterior cover with the second screw.

13. The imaging apparatus according to claim 12, wherein
the base member includes a recessed portion for accommodating the substrate,
the cover unit includes a pressing sheet disposed between the cover glass and the substrate accommodated in the recessed portion, and
the pressing sheet is elastically compressed in the laminating direction to position the substrate in the recessed portion by fastening the base member and the exterior cover with the second screw.
